(19) United States
(12) Patent Application Publication
(10) Pub. No.: US 2026/0261504 A1
(43) Pub. Date: Sep. 3, 2026

(54) COMPUTING POWER ROUTING SEARCHING METHOD AND APPARATUS, COMPUTING POWER NETWORK NODE AND STORAGE MEDIUM

(71) Applicant: ZTE CORPORATION, Shenzhen, Guangdong (CN)

(72) Inventors: Liwei MA, Shenzhen, Guangdong (CN); Guangping HUANG, Shenzhen, Guangdong (CN); Wei DUAN, Shenzhen, Guangdong (CN)

(21) Appl. No.: 18/878,430

(22) PCT Filed: Feb. 20, 2023
(86) PCT No.: PCT/CN2023/077213

§ 371 Date: Dec. 23, 2024

(30) Foreign Application Priority Data
Jun. 28, 2022 (CN) 202210753502.6

(51) Int. Cl. H04L 45/00; H04L 45/021

(52) U.S. Cl. CPC H04L 45/14; H04L 45/021

(57) ABSTRACT

Provided are a computing power routing search method and apparatus, a computing power network node, and a storage medium. The method includes, in response to receiving a computing power traffic message, parsing the computing power traffic message to obtain a computing power service identifier carried in the computing power traffic message, where the computing power service identifier includes an aggregation type and a service ID; searching a hierarchical computing power routing table for a computing power routing table home node corresponding to the computing power service identifier according to the aggregation type in the computing power service identifier; and in response to determining that the computing power routing table home node is found in the hierarchical computing power routing table, sending the computing power traffic message to the computing power routing table home node to enable the computing power routing table home node.

### TECHNICAL FIELD

Embodiments of the present application relate to the field of network technologies, for example, a computing power routing search method and apparatus, a computing power network node, and a storage medium.

### BACKGROUND

The computing power network leverages cloud-network convergence technologies as well as new networking technologies such as software-defined networking (SDN) and network function virtualization (NFV) to deeply integrate edge computing nodes, cloud computing nodes, and various network resources, including the wide area network (WAN). This reduces the management complexity of edge computing nodes. Through centralized control or distributed scheduling, it coordinates with the computing and storage resources of cloud computing nodes and the network resources of the WAN, forming a new generation of information infrastructure. This infrastructure provides customers with comprehensive computing power services that include computing, storage, and connectivity, and offers flexible, schedulable, on-demand services based on the characteristics of the service.

Computing power routing introduces computing power information into the routing domain. By sensing users' service requirements, computing resources, and network resources, it dynamically selects the target service node that meets the service requirements and schedules the service to the target service node along a specified path, thereby achieving global optimization of computing power and network resources. Computing power routing identifies computing power network nodes based on computing power enabling information reported by nodes, and it generates a computing power state topology by sensing and announcing computing power resources and service information. This further leads to the creation of a computing power-aware routing table. The computing power routing table is used for computing power routing addressing in computing power traffic forwarding, supporting the forwarding of computing power services. Current computing power routing technologies include computing power routing and forwarding based on the SRv6 network programmable protocol, computing power routing and forwarding based on the FIB forwarding flow table method, and computing power routing and forwarding based on service ID/function ID addressing.

During the implementation of the present application, the applicant has identified at least the following problem in the related art:

With the development of computing-network convergence technology and the increasing demand for computing-network services, the current computing routing and forwarding technologies under computing network architecture can no longer meet the requirements for large-scale deployment and multi-level granularity of computing resources and services in computing networks.

### SUMMARY

The present application provides a computing power routing search method and apparatus, a computing power network node, and a storage medium, effectively improving the retrieval efficiency of computing power traffic and globally optimizing computing power resources.

In a first aspect, an embodiment of the present application provides a computing power routing search method. The method is applied to the current computing power network node.

The method includes: in response to receiving a computing power traffic message, parsing the computing power traffic message to obtain a computing power service identifier carried in the computing power traffic message, where the computing power service identifier includes an aggregation type and a service ID; searching a precreated hierarchical computing power routing table for a computing power routing table home node corresponding to the computing power service identifier according to the aggregation type in the computing power service identifier; and in response to determining that the computing power routing table home node is found in the hierarchical computing power routing table, sending the computing power traffic message to the computing power routing table home node to enable the computing power routing table home node to perform computing power routing search processing on the computing power traffic message.

In a second aspect, an embodiment of the present application provides a computing power routing search apparatus. The apparatus includes a parsing module, a search module, and a processing module.

The parsing module is configured to, in response to receiving a computing power traffic message, parse the computing power traffic message to obtain a computing power service identifier carried in the computing power traffic message. Here the computing power service identifier includes an aggregation type and a service ID.

The search module is configured to search a precreated hierarchical computing power routing table for a computing power routing table home node corresponding to the computing power service identifier according to the aggregation type in the computing power service identifier.

The processing module is configured to, in response to determining that the computing power routing table home node is found in the hierarchical computing power routing table, send the computing power traffic message to the computing power routing table home node to enable the computing power routing table home node to perform computing power routing searching processing on the computing power traffic message.

In a third aspect, an embodiment of the present application provides a computing power network node.

The computing power network node includes a storage apparatus configured to store one or more programs.

When executed by the one or more processors, the one or more programs cause the one or more processors to perform the method of the first aspect of the present application.

In a fourth aspect, an embodiment of the present application provides a storage medium storing a computer program which, when executed by a processor, causes the processor to perform the method of any embodiment of the present application.

### BRIEF DESCRIPTION OF DRAWINGS

FIG. 1 is a first flowchart of a computing power routing search method according to an embodiment of the present application.

FIG. 2 is a schematic diagram of a first structure of a computing power service identifier based on an aggregation type according to an embodiment of the present application.

FIG. 3 is a second flowchart of a computing power routing search method according to an embodiment of the present application.

FIG. 4 is a third flowchart of a computing power routing search method according to an embodiment of the present application.

FIG. 5 is a diagram of a first network structure of hierarchical computing power routing based on the aggregation type according to an embodiment of the present application.

FIG. 6 is a fourth flowchart of a computing power routing search method according to an embodiment of the present application.

FIG. 7 is a fifth flowchart of a computing power routing search method according to an embodiment of the present application.

FIG. 8 is a schematic diagram of a second structure of a computing power service identifier based on an aggregation type according to an embodiment of the present application.

FIG. 9 is a diagram of a second network structure for hierarchical computing power routing based on the aggregation type according to an embodiment of the present application.

FIG. 10 is a schematic diagram of a network structure of encapsulation of a computing power service identifier based on an aggregation type according to an embodiment of the present application.

FIG. 11 is a diagram of the structure of a computing power routing search apparatus according to an embodiment of the present application.

FIG. 12 is a diagram of the structure of a computing power network node according to an embodiment of the present application.

### DETAILED DESCRIPTION

The steps illustrated in the flowcharts among the drawings may be performed by, for example, a computer system capable of executing a set of computer-executable instructions. Moreover, though logical sequences are illustrated in the flowcharts, in some cases, the steps illustrated or described may be performed in sequences different from the sequences described herein.

### Embodiment One

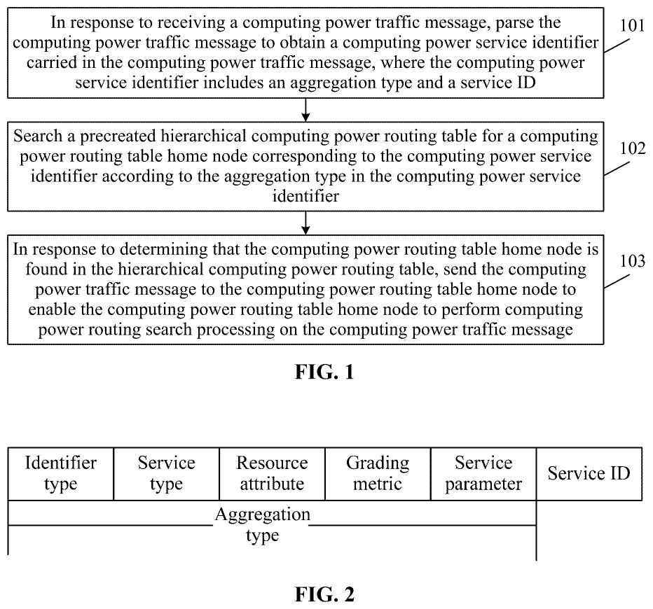

FIG. 1 is a first flowchart of a computing power routing search method according to an embodiment of the present application. The method may be executed by a computing power routing search apparatus or a computing power network node. The apparatus or the computing power network node may be implemented by software and/or hardware. The apparatus or the computing power network node may be integrated in any smart device having network communication capabilities. As shown in FIG. 1, the computing power routing search method may include S101, S102, and S103.

In S101, in response to receiving a computing power traffic message, the computing power traffic message is parsed to obtain a computing power service identifier carried in the computing power traffic message, where the computing power service identifier includes an aggregation type and a service ID.

In this step, in response to receiving a computing power traffic message, the current computing power network node may parse the computing power traffic message to obtain a computing power service identifier carried in the computing power traffic message, where the computing power service identifier includes at least an aggregation type and a service ID. This embodiment of the present application defines the computing power service identifier in a structured manner by expanding the aggregation type based on the service ID. The aggregation type and the service ID are a whole encapsulated in the traffic message. Here the traffic message includes a network layer protocol message, a transport layer protocol message, and an application layer protocol message.

FIG. 2 is a schematic diagram of a first structure of a computing power service identifier based on an aggregation type according to an embodiment of the present application. As shown in FIG. 2, the computing power service identifier in this embodiment of the present application may include an aggregation type and a service ID. The aggregation type may include N aggregation categories. Here N is a natural number greater than or equal to 1. For example, the aggregation categories include, but are not limited to, an identifier type, a service type, a resource attribute, a grading metric, and a service parameter.

The identifier type is used for identifying the computing power service identifier and distinguishing the computing power service identifier from a traditional routing identifier. The service type is used for aggregation of computing power types, including, but not limited to, a computing power service type and a network connection service type. The resource attribute is used for aggregation of computing power resource attributes and aggregation of network resource attributes. Aggregation of computing power resource attributes includes, but is not limited to, aggregation by service, aggregation by microservice, aggregation by algorithm, aggregation by function, aggregation by data structure, aggregation by position, aggregation by provider, or aggregation by cost. Aggregation of network resource attributes includes, but is not limited to, bandwidth resource aggregation, reliability resource aggregation, or latency requirement resource aggregation. The grading metric indicates computing power level aggregation, including, but not limited to, high and low priority aggregation, slicing aggregation, and queue aggregation. The service parameter is used for broadening the defined type aggregation by carrying information such as user parameters and flow characteristic parameters. The computing power service identifier has global or domain-wide semantics in the network layer control plane and forwarding plane, describing an independent and callable atomized computing power service.

The identifier type, service type, resource attribute, grading metric, and service parameter may serve as the aggregation categories of the computing power service identifier. In the computing power service identifier, there may be one or more of these aggregation categories. Based on these aggregation categories, generation and recursive query of a hierarchical routing table can be achieved. These aggregation categories are refined progressively from a coarse grain to a fine grain. The corresponding hierarchical computing power routing table is also created progressively from a coarse grain to a fine grain.

In S102, a precreated hierarchical computing power routing table is searched for a computing power routing table home node corresponding to the computing power service identifier according to the aggregation type in the computing power service identifier.

In this step, the current computing power network node can search for the computing power routing table home node corresponding to the computing power service identifier in the precreated hierarchical computing power routing table based on the aggregation type in the computing power service identifier. In an embodiment, the current computing power network node may first extract the aggregation type from the computing power service identifier and then search for the computing power routing table home node corresponding to the computing power service identifier in the hierarchical computing power routing table based on the aggregation type. For example, it is assumed that the aggregation type in the computing power service identifier includes an identifier type, a service type, a resource attribute, a grading metric, and a service parameter. The current computing power network node may first perform a search in the hierarchical computing power routing table based on the identifier type. If the computing power routing table home node is not found in the hierarchical computing power routing table based on the identifier type, the search can then be performed based on the service type. The rest can be done in the same manner.

In S103, in response to determining that the computing power routing table home node is found in the hierarchical computing power routing table, the computing power traffic message is sent to the computing power routing table home node to enable the computing power routing table home node to perform computing power routing search processing on the computing power traffic message.

In this step, if the computing power routing table home node is found in the hierarchical computing power routing table, the current computing power network node may send the computing power traffic message to the computing power routing table home node, enabling the computing power routing table home node to perform computing power routing search processing on the computing power traffic message. In this embodiment of the present application, the computing power routing table home node may be either a computing power network node or a computing power service node. If the computing power routing table home node is a computing power network node, after the current computing power network node sends the computing power traffic message to the computing power routing table home node, the computing power routing table home node continues to perform the operation of searching the precreated hierarchical computing power routing table for the computing power routing table home node corresponding to the computing power service identifier according to the aggregation type in the computing power service identifier. If the computing power routing table home node is a computing power service node, then after the current computing power network node sends the computing power traffic message to the computing power routing table home node, the computing power routing table home node can provide a computing power service for the computing power traffic message.

The computing power routing search method of this embodiment of the present application includes, in response to receiving a computing power traffic message, parsing the computing power traffic message to obtain a computing power service identifier carried in the computing power traffic message, where the computing power service identifier includes an aggregation type and a service ID; searching a hierarchical computing power routing table for a computing power routing table home node corresponding to the computing power service identifier according to the aggregation type in the computing power service identifier; and in response to determining that the computing power routing table home node is found in the hierarchical computing power routing table, sending the computing power traffic message to the computing power routing table home node to enable the computing power routing table home node to perform computing power routing search processing on the computing power traffic message. In other words, in the solution of the present application, the hierarchical computing power routing table is created based on the aggregation type. The current computing power network node obtains the computing power routing table home node by searching this hierarchical computing power routing table, and then the computing power routing table home node does the computing power routing search. The aggregation type of this embodiment of the present application is progressively refined from a coarse grain to a fine grain. The corresponding hierarchical computing power routing table is created in a manner that follows this progression from a coarse grain to a fine grain. This hierarchical search method significantly improves the search efficiency and enhances the computing power network service experience. In contrast, the related art typically does a search based on the service ID in the precreated computing power routing table. Since the computing power routing table in the related art is created in a non-hierarchical manner, the search efficiency is very low, making it difficult to meet the requirements of large-scale deployment of computing power networks and the multi-level granularity of computing power resources and services. Therefore, compared to the related art, the computing power routing search method provided in this embodiment of the present application can effectively improve the search efficiency of the computing power traffic, thereby achieving global optimization of computing power resources. Additionally, the solution of this embodiment is simple and convenient to implement, easy to popularize, and has a broader scope of application.

### Embodiment Two

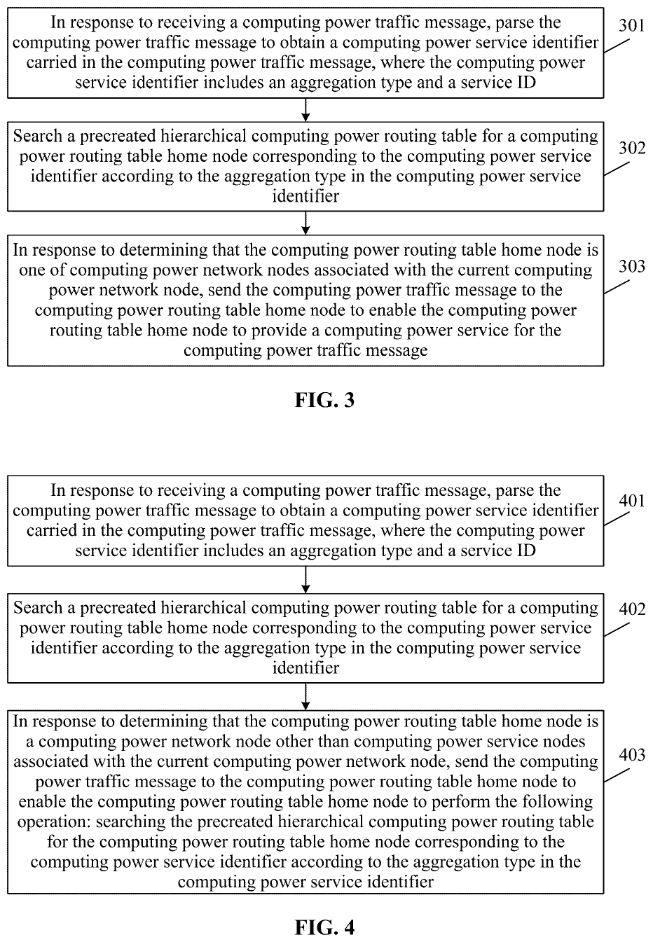

FIG. 3 is a second flowchart of a computing power routing search method according to an embodiment of the present application. This embodiment is an optimization and expansion of the previous solution. This embodiment can be combined with each previous embodiment. As shown in FIG. 3, the computing power routing search method may include S301, S302, and S303.

In S301, in response to receiving a computing power traffic message, the computing power traffic message is parsed to obtain a computing power service identifier carried in the computing power traffic message, where the computing power service identifier includes an aggregation type and a service ID.

In S302, a precreated hierarchical computing power routing table is searched for a computing power routing table home node corresponding to the computing power service identifier according to the aggregation type in the computing power service identifier.

In S303, in response to determining that the computing power routing table home node is one of computing power network nodes associated with the current computing power network node, the computing power traffic message is sent to the computing power routing table home node to enable the computing power routing table home node to provide a computing power service for the computing power traffic message.

In this step, in response to determining that the computing power routing table home node is one of computing power network nodes associated with the current computing power network node, the current computing power network node may send the computing power traffic message to the computing power routing table home node to enable the computing power routing table home node to provide a computing power service for the computing power traffic message. For example, it is assumed that the computing power network node A is associated with the computing power service node A1. When receiving a computing power traffic message, the computing power network node A first parses the computing power traffic message to obtain the computing power service identifier carried in the computing power traffic message and then searches the hierarchical computing power routing table for the corresponding computing power routing table home node according to the aggregation type in the computing power service identifier. If the computing power routing table home node at this point is the computing power service node A1, then the computing power network node A may send the computing power traffic message to the computing power service node A1 to enable the computing power service node A1 to provide a computing power service for the computing power traffic message.

In this embodiment of the present application, each computing power service node has a computing power routing table containing the corresponding aggregation identifier. For example, the computing power service node A has a computing power routing table containing the aggregation identifier A.

The computing power routing search method of this embodiment of the present application includes, in response to receiving a computing power traffic message, parsing the computing power traffic message to obtain a computing power service identifier carried in the computing power traffic message, where the computing power service identifier includes an aggregation type and a service ID; searching a hierarchical computing power routing table for a computing power routing table home node corresponding to the computing power service identifier according to the aggregation type in the computing power service identifier; and in response to determining that the computing power routing table home node is found in the hierarchical computing power routing table, sending the computing power traffic message to the computing power routing table home node to enable the computing power routing table home node to perform computing power routing search processing on the computing power traffic message. In other words, in the solution of the present application, the hierarchical computing power routing table is created based on the aggregation type. The current computing power network node obtains the computing power routing table home node by searching this hierarchical computing power routing table, and then the computing power routing table home node does the computing power routing search. The aggregation type of this embodiment of the present application is progressively refined from a coarse grain to a fine grain. The corresponding hierarchical computing power routing table is created in a manner that follows this progression from a coarse grain to a fine grain. This hierarchical search method significantly improves the search efficiency and enhances the computing power network service experience. In contrast, the related art typically does a search based on the service ID in the precreated computing power routing table. Since the computing power routing table in the related art is created in a non-hierarchical manner, the search efficiency is very low, making it difficult to meet the requirements of large-scale deployment of computing power networks and the multi-level granularity of computing power resources and services. Therefore, compared to the related art, the computing power routing search method provided in this embodiment of the present application can effectively improve the search efficiency of the computing power traffic, thereby achieving global optimization of computing power resources. Additionally, the solution of this embodiment is simple and convenient to implement, easy to popularize, and has a broader scope of application.

### Embodiment Three

FIG. 4 is a third flowchart of a computing power routing search method according to an embodiment of the present application. This embodiment is an optimization and expansion of the previous solution. This embodiment can be combined with each previous embodiment. As shown in FIG. 4, the computing power routing search method may include S401, S402, and S403.

In S401, in response to receiving a computing power traffic message, the computing power traffic message is parsed to obtain a computing power service identifier carried in the computing power traffic message, where the computing power service identifier includes an aggregation type and a service ID.

In S402, a precreated hierarchical computing power routing table is searched for a computing power routing table home node corresponding to the computing power service identifier according to the aggregation type in the computing power service identifier.

In S403, in response to determining that the computing power routing table home node is a computing power network node other than computing power service nodes associated with the current computing power network node, the computing power traffic message is sent to the computing power routing table home node to enable the computing power routing table home node to perform the following operation: searching the precreated hierarchical computing power routing table for the computing power routing table home node corresponding to the computing power service identifier according to the aggregation type in the computing power service identifier.

In this step, in response to determining that the computing power routing table home node is a computing power network node other than computing power service nodes associated with the current computing power network node, the current computing power network node may send the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier. For example, it is assumed that the computing power network node A is associated with the computing power service node A1, and the computing power network node B is associated with the computing power service node B1. When receiving a computing power traffic message, the computing power network node A first parses the computing power traffic message to obtain the computing power service identifier carried in the computing power traffic message and then searches the hierarchical computing power routing table for the corresponding computing power routing table home node according to the aggregation type in the computing power service identifier. If the computing power routing table home node at this point is the computing power network node B, then the computing power network node A may send the computing power traffic message to the computing power network node B to enable the computing power network node B to perform the operation of searching the precreated hierarchical computing power routing table for the computing power routing table home node corresponding to the computing power service identifier according to the aggregation type in the computing power service identifier.

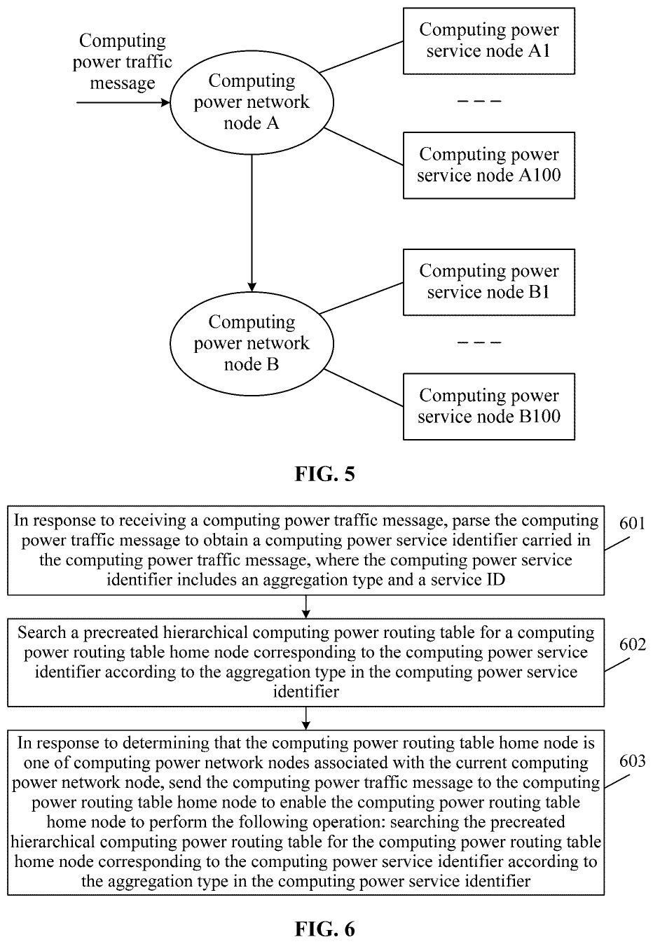

FIG. 5 is a diagram of a first network structure of hierarchical computing power routing based on the aggregation type according to an embodiment of the present application. As shown in FIG. 5, the computing power network node A is directly or indirectly associated with multiple computing power service nodes: A1, A2, . . . , and A100; and the computing power network node B is directly or indirectly associated with multiple computing power service nodes: B1, B2, . . . , and B100. The computing power service node A1 provides a computing power service having the computing power service identifier A1, the computing power service node A2 provides a computing power service having the computing power service identifier A2, . . . , and the computing power service node A100 provides a computing power service having the computing power service identifier A100. The computing power service node B1 provides a computing power service having the computing power service identifier B1, the computing power service node B2 provides a computing power service having the computing power service identifier B2, . . . , and the computing power service node B100 provides a computing power service having the computing power service identifier B100. In an embodiment, a hierarchical computing power routing table entry A is generated based on aggregation types A1, A2, . . . , and A100; and a hierarchical computing power routing table entry B is generated based on aggregation types B1, B2, . . . , and B100. When receiving a computing power traffic message carrying the computing power service identifier B100, the computing power network node A searches the hierarchical computing power routing table according to the aggregation type B in the computing power service identifier and retrieves that the computing power routing table home node corresponding to the computing power service identifier is the computing power network node B. At this point, the computing power network node A sends the computing power traffic message to the computing power network node B for computing power routing search processing.

The computing power routing search method of this embodiment of the present application includes, in response to receiving a computing power traffic message, parsing the computing power traffic message to obtain a computing power service identifier carried in the computing power traffic message, where the computing power service identifier includes an aggregation type and a service ID; searching a hierarchical computing power routing table for a computing power routing table home node corresponding to the computing power service identifier according to the aggregation type in the computing power service identifier; and in response to determining that the computing power routing table home node is found in the hierarchical computing power routing table, sending the computing power traffic message to the computing power routing table home node to enable the computing power routing table home node to perform computing power routing search processing on the computing power traffic message. In other words, in the solution of the present application, the hierarchical computing power routing table is created based on the aggregation type. The current computing power network node obtains the computing power routing table home node by searching this hierarchical computing power routing table, and then the computing power routing table home node does the computing power routing search. The aggregation type of this embodiment of the present application is progressively refined from a coarse grain to a fine grain. The corresponding hierarchical computing power routing table is created in a manner that follows this progression from a coarse grain to a fine grain. This hierarchical search method significantly improves the search efficiency and enhances the computing power network service experience. In contrast, the related art typically does a search based on the service ID in the precreated computing power routing table. Since the computing power routing table in the related art is created in a non-hierarchical manner, the search efficiency is very low, making it difficult to meet the requirements of large-scale deployment of computing power networks and the multi-level granularity of computing power resources and services. Therefore, compared to the related art, the computing power routing search method provided in this embodiment of the present application can effectively improve the search efficiency of the computing power traffic, thereby achieving global optimization of computing power resources. Additionally, the solution of this embodiment is simple and convenient to implement, easy to popularize, and has a broader scope of application.

### Embodiment Four

FIG. 6 is a fourth flowchart of a computing power routing search method according to an embodiment of the present application. This embodiment is an optimization and expansion of the previous solution. This embodiment can be combined with each previous embodiment. As shown in FIG. 6, the computing power routing search method may include S601, S602, and S603.

In S601, in response to receiving a computing power traffic message, the computing power traffic message is parsed to obtain a computing power service identifier carried in the computing power traffic message, where the computing power service identifier includes an aggregation type and a service ID.

In S602, a precreated hierarchical computing power routing table is searched for a computing power routing table home node corresponding to the computing power service identifier according to the aggregation type in the computing power service identifier.

In S603, in response to determining that the computing power routing table home node is one of computing power network nodes associated with the current computing power network node, the computing power traffic message is sent to the computing power routing table home node to enable the computing power routing table home node to perform the following operation: searching the precreated hierarchical computing power routing table for the computing power routing table home node corresponding to the computing power service identifier according to the aggregation type in the computing power service identifier.

In this step, in response to determining that the computing power routing table home node is one of computing power network nodes associated with the current computing power network node, the current computing power network node may send the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier. In this embodiment of the present application, each computing power network node may be directly or indirectly associated with multiple computing power network nodes or multiple computing power service nodes. For example, it is assumed that the computing power network node Am is associated with the computing power network node Am1. When receiving a computing power traffic message, the computing power network node A first parses the computing power traffic message to obtain the computing power service identifier carried in the computing power traffic message and then searches the hierarchical computing power routing table for the corresponding computing power routing table home node according to the aggregation type in the computing power service identifier. If the computing power routing table home node at this point is the computing power network node Am1, then the computing power network node Am may send the computing power traffic message to the computing power network node Am1 to enable the computing power network node Am1 to perform the operation of searching the precreated hierarchical computing power routing table for the computing power routing table home node corresponding to the computing power service identifier according to the aggregation type in the computing power service identifier. If the computing power routing table home node at this point is the computing power network node Am11, then the computing power network node Am1 may send the computing power traffic message to the computing power network node Am11 to enable the computing power network node Am11 to provide a computing power service for the computing power traffic message.

The computing power routing search method of this embodiment of the present application includes, in response to receiving a computing power traffic message, parsing the computing power traffic message to obtain a computing power service identifier carried in the computing power traffic message, where the computing power service identifier includes an aggregation type and a service ID; searching a hierarchical computing power routing table for a computing power routing table home node corresponding to the computing power service identifier according to the aggregation type in the computing power service identifier; and in response to determining that the computing power routing table home node is found in the hierarchical computing power routing table, sending the computing power traffic message to the computing power routing table home node to enable the computing power routing table home node to perform computing power routing search processing on the computing power traffic message. In other words, in the solution of the present application, the hierarchical computing power routing table is created based on the aggregation type. The current computing power network node obtains the computing power routing table home node by searching this hierarchical computing power routing table, and then the computing power routing table home node does the computing power routing search. The aggregation type of this embodiment of the present application is progressively refined from a coarse grain to a fine grain. The corresponding hierarchical computing power routing table is created in a manner that follows this progression from a coarse grain to a fine grain. This hierarchical search method significantly improves the search efficiency and enhances the computing power network service experience. In contrast, the related art typically does a search based on the service ID in the precreated computing power routing table. Since the computing power routing table in the related art is created in a non-hierarchical manner, the search efficiency is very low, making it difficult to meet the requirements of large-scale deployment of computing power networks and the multi-level granularity of computing power resources and services. Therefore, compared to the related art, the computing power routing search method provided in this embodiment of the present application can effectively improve the search efficiency of the computing power traffic, thereby achieving global optimization of computing power resources. Additionally, the solution of this embodiment is simple and convenient to implement, easy to popularize, and has a broader scope of application.

### Embodiment Five

FIG. 7 is a fifth flowchart of a computing power routing search method according to an embodiment of the present application. This embodiment is an optimization and expansion of the previous solution. This embodiment can be combined with each previous embodiment. As shown in FIG. 7, the computing power routing search method may include S701, S702, and S703.

In S701, in response to receiving a computing power traffic message, the computing power traffic message is parsed to obtain a computing power service identifier carried in the computing power traffic message, where the computing power service identifier includes an aggregation type and a service ID.

In S702, a precreated hierarchical computing power routing table is searched for a computing power routing table home node corresponding to the computing power service identifier according to the aggregation type in the computing power service identifier.

In S703, in response to determining that the computing power routing table home node is a computing power network node other than computing power network nodes associated with the current computing power network node, the computing power traffic message is sent to the upper-level computing power network node of the current computing power network node to enable the upper-level computing power network node to perform the following operation: searching the precreated hierarchical computing power routing table for the computing power routing table home node corresponding to the computing power service identifier according to the aggregation type in the computing power service identifier.

In this step, in response to determining that the computing power routing table home node is a computing power network node other than computing power service nodes associated with the current computing power network node, the current computing power network node may send the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier. For example, it is assumed that the computing power network node A is associated with the computing power network nodes Am and An, the computing power network node Am is associated with the computing network node Am1, the computing power network node Am1 is associated with the computing service node Am11, the computing power network node An is associated with the computing network node An1, the computing power network node An1 is associated with the computing network service An11. When receiving a computing power traffic message, the computing power network node Am first parses the computing power traffic message to obtain the computing power service identifier carried in the computing power traffic message and then searches the hierarchical computing power routing table for the corresponding computing power routing table home node according to the aggregation type in the computing power service identifier. If at this point, the computing power network node Am cannot find the computing power routing table home node corresponding to the computing power service identifier, then the computing power network node Am may send the computing power traffic message to the computing power network node A to enable the computing power network node A to perform the operation of searching the precreated hierarchical computing power routing table for the computing power routing table home node corresponding to the computing power service identifier according to the aggregation type in the computing power service identifier.

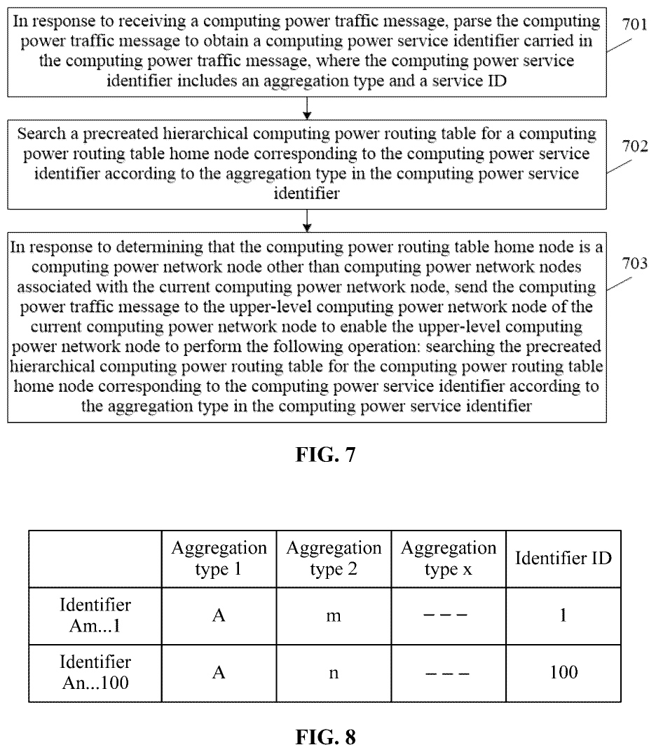

FIG. 8 is a schematic diagram of a second structure of a computing power service identifier based on an aggregation type according to an embodiment of the present application. As shown in FIG. 8, the computing power service identifier may include x aggregation types and an identifier (ID). Here the x aggregation types are aggregation type 1, aggregation type 2, . . . , and aggregation type x. Under the computing power service identifier Am . . . 1, the aggregation types are A, m, . . . , and the identifier (ID) is 1. Under the computing power service identifier An . . . 1, the aggregation types are A, n, . . . , and the identifier (ID) is 100.

FIG. 9 is a diagram of a second network structure for hierarchical computing power routing based on the aggregation type according to an embodiment of the present application. As shown in FIG. 9, the computing power service node An1 provides a computing power service having the computing power service identifier An1, the computing power service node An2 provides a computing power service having the computing power service identifier An2, . . . , and the computing power service node An100 provides a computing power service having the computing power service identifier An100. The computing power network node An can generate routes to the computing power service nodes An . . . 100 and aggregate them into a hierarchical computing power routing table of the aggregation type An. Similarly, the computing power network node Am can generate a hierarchical computing power routing table of the aggregation type Am.

When receiving a computing power traffic message carrying the computing power service identifier Am100, the computing power network node searches the hierarchical computing power routing table according to the aggregation type Am in the computing power service identifier. At this point, no computing power home node is matched. The computing power network node An may parse the computing power service identifier A and retrieve the computing power network node A as the computing power home node. The computing power network node An sends the computing power traffic message to the computing power network node A for computing power routing search processing. The computing power network node A searches the hierarchical computing power routing table according to the aggregation type Am in the computing power service identifier to acquire information about the computing power network node Am as the computing power home node. Then the computing power network node A performs subsequent computing power routing processing.

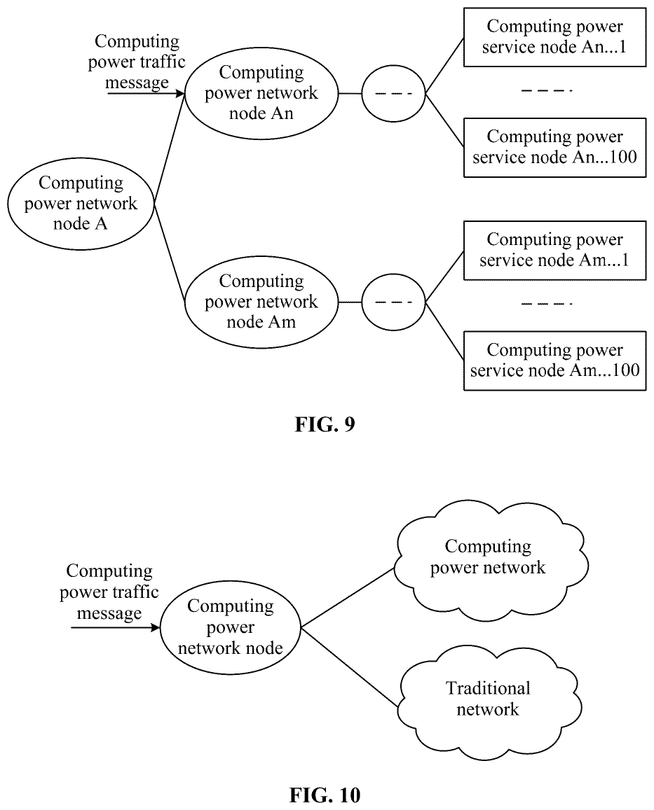

FIG. 10 is a schematic diagram of a network structure of encapsulation of a computing power service identifier based on an aggregation type according to an embodiment of the present application. As shown in FIG. 10, the identifier type field can be used to distinguish between the computing power service identifier (service ID) and a traditional routing IP address identifier. When a computing power traffic message arrives at a computing power network node, the identifier type field in the aggregation type is parsed. If the identifier type is a computing power service identifier type, the traffic is routed into a computing power network for further processing. If the identifier type is a traditional address identifier type, the traffic is routed into a traditional network for further processing.

The computing power routing search method of this embodiment of the present application includes, in response to receiving a computing power traffic message, parsing the computing power traffic message to obtain a computing power service identifier carried in the computing power traffic message, where the computing power service identifier includes an aggregation type and a service ID; searching a hierarchical computing power routing table for a computing power routing table home node corresponding to the computing power service identifier according to the aggregation type in the computing power service identifier; and in response to determining that the computing power routing table home node is found in the hierarchical computing power routing table, sending the computing power traffic message to the computing power routing table home node to enable the computing power routing table home node to perform computing power routing search processing on the computing power traffic message. In other words, in the solution of the present application, the hierarchical computing power routing table is created based on the aggregation type. The current computing power network node obtains the computing power routing table home node by searching this hierarchical computing power routing table, and then the computing power routing table home node does the computing power routing search. The aggregation type of this embodiment of the present application is progressively refined from a coarse grain to a fine grain. The corresponding hierarchical computing power routing table is created in a manner that follows this progression from a coarse grain to a fine grain. This hierarchical search method significantly improves the search efficiency and enhances the computing power network service experience. In contrast, the related art typically does a search based on the service ID in the precreated computing power routing table. Since the computing power routing table in the related art is created in a non-hierarchical manner, the search efficiency is very low, making it difficult to meet the requirements of large-scale deployment of computing power networks and the multi-level granularity of computing power resources and services. Therefore, compared to the related art, the computing power routing search method provided in this embodiment of the present application can effectively improve the search efficiency of the computing power traffic, thereby achieving global optimization of computing power resources. Additionally, the solution of this embodiment is simple and convenient to implement, easy to popularize, and has a broader scope of application.

### Embodiment Six

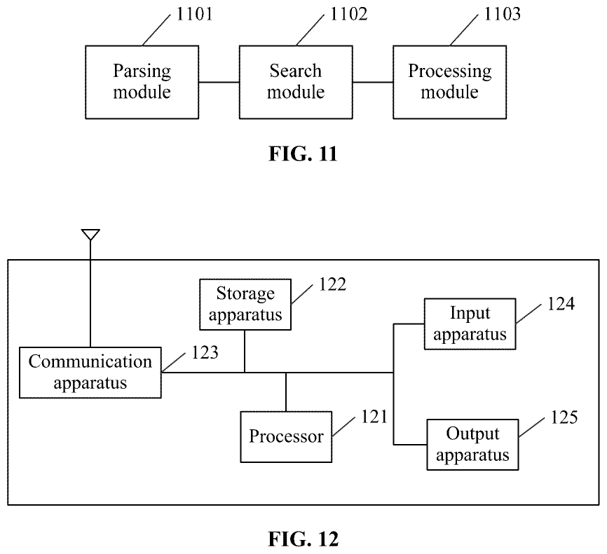

FIG. 11 is a diagram of the structure of a computing power routing search apparatus according to an embodiment of the present application. As shown in FIG. 11, the computing power routing search apparatus includes a parsing module 1101, a search module 1102, and a processing module 1103.

The parsing module 1101 is configured to, in response to receiving a computing power traffic message, parse the computing power traffic message to obtain a computing power service identifier carried in the computing power traffic message. Here the computing power service identifier includes at least an aggregation type and a service ID.

The search module 1102 is configured to search a precreated hierarchical computing power routing table for a computing power routing table home node corresponding to the computing power service identifier according to the aggregation type in the computing power service identifier.

The processing module 1103 is configured to, in response to determining that the computing power routing table home node is found in the hierarchical computing power routing table, send the computing power traffic message to the computing power routing table home node to enable the computing power routing table home node to perform computing power routing searching processing on the computing power traffic message.

In an embodiment, the aggregation type includes N aggregation categories. N denotes a natural number greater than or equal to 1.

In an embodiment, the aggregation categories include an identifier type, a service type, a resource attribute, a grading metric, and a service parameter.

In an embodiment, the processing module 1103 is configured to, in response to determining that the computing power routing table home node is one of computing power network nodes associated with the current computing power network node, send the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier.

In an embodiment, the processing module 1103 is also configured to, in response to determining that the computing power routing table home node is a computing power network node other than computing power network nodes associated with the current computing power network node, send the computing power traffic message to an upper-level computing power network node of the current computing power network node to enable the upper-level computing power network node to perform the following operation: searching the precreated hierarchical computing power routing table for the computing power routing table home node corresponding to the computing power service identifier according to the aggregation type in the computing power service identifier.

In an embodiment, the processing module 1103 is also configured to, in response to determining that the computing power routing table home node is one of computing power network nodes associated with the current computing power network node, send the computing power traffic message to the computing power routing table home node to enable the computing power routing table home node to provide a computing power service for the computing power traffic message.

In an embodiment, the processing module 1103 is also configured to, in response to determining that the computing power routing table home node is a computing power network node other than computing power service nodes associated with the current computing power network node, send the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier.

The computing power routing search apparatus can execute the method of any embodiment of the present application. The computing power routing search apparatus has function modules and beneficial effects corresponding to the executed method. For technical details not described in detail in this embodiment, see the computing power routing search method of any embodiment of the present application.

### Embodiment Seven

FIG. 12 is a diagram of the structure of a computing power network node according to an embodiment of the present application. As shown in FIG. 12, the computing power network node of the present application includes one or more processors 121 and a storage apparatus 122. One or more processors 121 may be disposed in the computing power network node. FIG. 12 uses one processor 121 as an example. The storage apparatus 122 is configured to store one or more programs. When executed by the one or more processors 121, the one or more programs cause the one or more processors 121 to perform the computing power routing search method of any embodiment of the present application.

The computing power network node also includes a communication apparatus 123, an input apparatus 124, and an output apparatus 125.

The processor 121, the storage apparatus 122, the communication apparatus 123, the input apparatus 124, and the output apparatus 125 in the computing power network node may be connected via a bus or in other manners. FIG. 12 uses connection via a bus as an example.

The input apparatus 124 may be configured to receive input digital or character information and generate key signal input related to user settings and function control of the computing power network node. The output apparatus 125 may include a display device such as a display screen.

The communication apparatus 123 may include a receiver and a sender. The communication apparatus 123 is configured to do a computing power routing search under the control of the processor 121.

As a computer-readable storage medium, the storage apparatus 122 may be configured to store software programs, computer-executable programs, and modules, such as program instructions/modules (for example, the parsing module 1101, the search module 1102, and the processing module 1103 in the computing power routing search apparatus) corresponding to the computing power routing search method of any embodiment of the present application. The storage apparatus 122 may include a program storage region and a data storage region. The program storage region may store an operating system and an application program required by at least one function. The data storage region may store data created according to the use of the device. Additionally, the storage apparatus 122 may include a high-speed random-access memory and may further include a nonvolatile memory, such as at least one magnetic disk memory, a flash memory, or another nonvolatile solid-state memory. In some examples, the storage apparatus 122 may also include memories remote from the processor 121 and connectable to the computing power network node via a network. Examples of the preceding network include, but are not limited to, the Internet, an intranet, a local area network, a mobile communication network, and a combination thereof.

### Embodiment Eight

An embodiment of the present application provides a storage medium storing a computer program which, when executed by a processor, causes the processor to perform the method of any embodiment of the present application.

For example, provided is a computing power routing search method. The method is applied to the current computing power network node.

The method includes, in response to receiving a computing power traffic message, parsing the computing power traffic message to obtain a computing power service identifier carried in the computing power traffic message, where the computing power service identifier includes an aggregation type and a service ID; searching a precreated hierarchical computing power routing table for a computing power routing table home node corresponding to the computing power service identifier according to the aggregation type in the computing power service identifier; and in response to determining that the computing power routing table home node is found in the hierarchical computing power routing table, sending the computing power traffic message to the computing power routing table home node to enable the computing power routing table home node to perform computing power routing search processing on the computing power traffic message.

A computer storage medium in an embodiment of the present application may be one computer-readable medium or any combination of multiple computer-readable media. The computer-readable medium may be a computer-readable signal medium or a computer-readable storage medium. For example, the computer-readable storage medium may be, but is not limited to, an electrical, magnetic, optical, electromagnetic, infrared, or semiconductor system, apparatus, or device or any combination thereof. Examples of the computer-readable storage medium (a non-exhaustive list) include an electrical connection having one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical memory, a magnetic memory, or any suitable combination thereof. The computer-readable storage medium may be any tangible medium including or storing a program. The program may be used by or used in conjunction with an instruction execution system, apparatus, or device.

The computer-readable signal medium may include a data signal propagated in a baseband or as part of a carrier. The data signal carries computer-readable program codes. The data signal propagated in this manner may be in multiple forms, including, but not limited to, an electromagnetic signal, an optical signal, or any suitable combination thereof. The computer-readable signal medium may also be any computer-readable medium other than the computer-readable storage medium. The computer-readable medium may send, propagate, or transmit a program used by or used in conjunction with an instruction execution system, apparatus, or device.

Program codes included in the computer-readable media may be transmitted by any suitable medium including, but not limited to, a wireless medium, a wire, an optical cable, a radio frequency (RF), or any suitable combination thereof.

Computer program codes for performing the operations of the present application may be written in one or more programming languages or a combination of multiple programming languages. The programming languages include object-oriented programming languages such as Java, Smalltalk, and C++ and may further include conventional procedural programming languages such as “C” or similar programming languages. The program codes may be executed entirely on a user computer, executed partly on a user computer, executed as a stand-alone software package, executed partly on a user computer and partly on a remote computer, or executed entirely on a remote computer or a server. In the case where the remote computer is involved, the remote computer may be connected to the user computer through any type of network including a local area network (LAN) or a wide area network (WAN), or may be connected to an external computer (for example, via the Internet provided by an Internet service provider).

The preceding are example embodiments of the present application and are not intended to limit the scope of the present application.

It is to be understood by those skilled in the art that the term “user equipment” encompasses any suitable type of radio user device such as a mobile phone, a portable data processing apparatus, a portable web browser or an in-vehicle mobile station.

Generally speaking, embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present application may represent program steps, may represent interconnected logic circuits, modules, and functions, or may represent a combination of program steps and logic circuits, modules, and functions. Computer programs may be stored in a memory. The memory may be of any type suitable for a local technical environment and may be implemented using any suitable data storage technology, such as, but not limited to, a read-only memory (ROM), a random-access memory (RAM), or an optical memory device and system (for example, a digital video disc (DVD) or a compact disc (CD)). Computer-readable media may include non-transitory storage media. The data processor may be of any type suitable for the local technical environment, such as, but not limited to, a general-purpose computer, a special-purpose computer, a microprocessor, a digital signal processor (DSP), an application-specific integrated circuit (ASIC), a field-programmable gate array (FPGA), and a processor based on a multi-core processor architecture.

1. A computing power routing search method, applied to a current computing power network node, comprising:
in response to receiving a computing power traffic message, parsing the computing power traffic message to obtain a computing power service identifier carried in the computing power traffic message, wherein the computing power service identifier comprises an aggregation type and a service ID;
searching a precreated hierarchical computing power routing table for a computing power routing table home node corresponding to the computing power service identifier according to the aggregation type in the computing power service identifier; and
in response to determining that the computing power routing table home node is found in the hierarchical computing power routing table, sending the computing power traffic message to the computing power routing table home node to enable the computing power routing table home node to perform computing power routing search processing on the computing power traffic message.

2. The method of claim 1, wherein the aggregation type comprises N aggregation categories, wherein N denotes a natural number greater than or equal to 1.

3. The method of claim 2, wherein the aggregation categories comprise an identifier type, a service type, a resource attribute, a grading metric, and a service parameter.

4. The method of claim 1, wherein sending the computing power traffic message to the computing power routing table home node to enable the computing power routing table home node to perform the computing power routing search processing on the computing power traffic message comprises:
in response to determining that the computing power routing table home node is one of computing power network nodes associated with the current computing power network node, sending the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier.

5. The method of claim 1, wherein sending the computing power traffic message to the computing power routing table home node to enable the computing power routing table home node to perform the computing power routing search processing on the computing power traffic message comprises:
in response to determining that the computing power routing table home node is a computing power network node other than computing power network nodes associated with the current computing power network node, sending the computing power traffic message to an upper-level computing power network node of the current computing power network node to enable the upper-level computing power network node to perform the following operation: searching the precreated hierarchical computing power routing table for the computing power routing table home node corresponding to the computing power service identifier according to the aggregation type in the computing power service identifier.

6. The method of claim 1, wherein sending the computing power traffic message to the computing power routing table home node to enable the computing power routing table home node to perform the computing power routing search processing on the computing power traffic message further comprises:
in response to determining that the computing power routing table home node is one of computing power network nodes associated with the current computing power network node, sending the computing power traffic message to the computing power routing table home node to enable the computing power routing table home node to provide a computing power service for the computing power traffic message.

7. The method of claim 1, wherein sending the computing power traffic message to the computing power routing table home node to enable the computing power routing table home node to perform the computing power routing search processing on the computing power traffic message comprises:
in response to determining that the computing power routing table home node is a computing power network node other than computing power service nodes associated with the current computing power network node, sending the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier.

8. (canceled)

9. A computing power network node, comprising:
one or more processors; and
a memory configured to store one or more programs,
wherein when executed by the one or more processors, the one or more programs cause the one or more processors to perform a computing power routing search method, wherein the computing power routing search method comprises:
in response to receiving a computing power traffic message, parsing the computing power traffic message to obtain a computing power service identifier carried in the computing power traffic message, wherein the computing power service identifier comprises an aggregation type and a service ID;
searching a precreated hierarchical computing power routing table for a computing power routing table home node corresponding to the computing power service identifier according to the aggregation type in the computing power service identifier; and
in response to determining that the computing power routing table home node is found in the hierarchical computing power routing table, sending the computing power traffic message to the computing power routing table home node to enable the computing power routing table home node to perform computing power routing search processing on the computing power traffic message.

10. A non-transitory storage medium storing a computer program which, when executed by a processor, causes the processor to perform a computing power routing search method, wherein the computing power routing search method comprises:
in response to receiving a computing power traffic message, parsing the computing power traffic message to obtain a computing power service identifier carried in the computing power traffic message, wherein the computing power service identifier comprises an aggregation type and a service ID;
searching a precreated hierarchical computing power routing table for a computing power routing table home node corresponding to the computing power service identifier according to the aggregation type in the computing power service identifier; and
in response to determining that the computing power routing table home node is found in the hierarchical computing power routing table, sending the computing power traffic message to the computing power routing table home node to enable the computing power routing table home node to perform computing power routing search processing on the computing power traffic message.

11. The computing power network node of claim 9, wherein the aggregation type comprises N aggregation categories, wherein N denotes a natural number greater than or equal to 1.

12. The computing power network node of claim 11, wherein the aggregation categories comprise an identifier type, a service type, a resource attribute, a grading metric, and a service parameter.

13. The computing power network node of claim 9, wherein sending the computing power traffic message to the computing power routing table home node to enable the computing power routing table home node to perform the computing power routing search processing on the computing power traffic message comprises:
in response to determining that the computing power routing table home node is one of computing power network nodes associated with the current computing power network node, sending the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier.

14. The computing power network node of claim 9, wherein sending the computing power traffic message to the computing power routing table home node to enable the computing power routing table home node to perform the computing power routing search processing on the computing power traffic message comprises:
in response to determining that the computing power routing table home node is a computing power network node other than computing power network nodes associated with the current computing power network node, sending the computing power traffic message to an upper-level computing power network node of the current computing power network node to enable the upper-level computing power network node to perform the following operation: searching the precreated hierarchical computing power routing table for the computing power routing table home node corresponding to the computing power service identifier according to the aggregation type in the computing power service identifier.

15. The computing power network node of claim 9, wherein sending the computing power traffic message to the computing power routing table home node to enable the computing power routing table home node to perform the computing power routing search processing on the computing power traffic message further comprises:
in response to determining that the computing power routing table home node is one of computing power network nodes associated with the current computing power network node, sending the computing power traffic message to the computing power routing table home node to enable the computing power routing table home node to provide a computing power service for the computing power traffic message.

16. The computing power network node of claim 9, wherein sending the computing power traffic message to the computing power routing table home node to enable the computing power routing table home node to perform the computing power routing search processing on the computing power traffic message comprises:
in response to determining that the computing power routing table home node is a computing power network node other than computing power service nodes associated with the current computing power network node, sending the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier.

17. The non-transitory storage medium of claim 10, wherein the aggregation type comprises N aggregation categories, wherein N denotes a natural number greater than or equal to 1.

18. The non-transitory storage medium of claim 17, wherein the aggregation categories comprise an identifier type, a service type, a resource attribute, a grading metric, and a service parameter.

19. The non-transitory storage medium of claim 10, wherein sending the computing power traffic message to the computing power routing table home node to enable the computing power routing table home node to perform the computing power routing search processing on the computing power traffic message comprises:
in response to determining that the computing power routing table home node is one of computing power network nodes associated with the current computing power network node, sending the computing power traffic message to the computing power routing table home node to enable the computing power routing table home node to perform the following operation: searching the precreated hierarchical computing power routing table for the computing power routing table home node corresponding to the computing power service identifier according to the aggregation type in the computing power service identifier.

20. The non-transitory storage medium of claim 10, wherein sending the computing power traffic message to the computing power routing table home node to enable the computing power routing table home node to perform the computing power routing search processing on the computing power traffic message comprises:
in response to determining that the computing power routing table home node is a computing power network node other than computing power network nodes associated with the current computing power network node, sending the computing power traffic message to an upper-level computing power network node of the current computing power network node to enable the upper-level computing power network node to perform the following operation: searching the precreated hierarchical computing power routing table for the computing power routing table home node corresponding to the computing power service identifier according to the aggregation type in the computing power service identifier.

21. The non-transitory storage medium of claim 10, wherein sending the computing power traffic message to the computing power routing table home node to enable the computing power routing table home node to perform the computing power routing search processing on the computing power traffic message further comprises:
in response to determining that the computing power routing table home node is one of computing power network nodes associated with the current computing power network node, sending the computing power traffic message to the computing power routing table home node to enable the computing power routing table home node to provide a computing power service for the computing power traffic message.
